(19) United States
(12) Patent Application Publication
(10) Pub. No.: US 2024/0198719 A1
(43) Pub. Date: Jun. 20, 2024

(54) COLOR PANEL, HOME APPLIANCE, AND METHOD FOR MANUFACTURING COLOR PANEL

(71) Applicant: SAMSUNG ELECTRONICS CO., LTD., Suwon-si (KR)

(72) Inventors: Minkyung LEE, Suwon-si (KR); Dosoo SUNG, Suwon-si (KR); Youngdeog KOH, Suwon-si (KR); Kwangjoo KIM, Suwon-si (KR)

(73) Assignee: SAMSUNG ELECTRONICS CO., LTD., Suwon-si (KR)

(21) Appl. No.: 18/594,477

(22) Filed: Mar. 4, 2024

Related U.S. Application Data
(63) Continuation of application No. PCT/KR2022/013962, filed on Sep. 19, 2022.

(30) Foreign Application Priority Data
Nov. 17, 2021 (KR) 10-2021-0158507

(51) Int. Cl. B44F 5/00; B44C 1/22; B44C 1/24

(52) U.S. Cl. CPC B44F 5/00; B44C 1/225; B44C 1/24

(57) ABSTRACT

A home appliance can include: a body having an opening; a door to open and close the opening; and a color panel on at least one of the body or the door, the color panel including: a base panel including: a front surface, and an uneven pattern portion on the front surface, having upper sides, and lower sides that are at a height difference from the upper sides, and a color layer on the uneven pattern portion and including: main ink dots and sub ink dots having a size that is smaller than the main ink dots, wherein at least one sub ink dot is between each two adjacent main ink dots, and at least some of the sub ink dots are on at least one of a periphery of the upper sides or a periphery of the lower sides.

### CROSS-REFERENCE TO RELATED APPLICATIONS

This is a continuation application of International Application No. PCT/KR2022/013962, filed Sep. 19, 2022, which is incorporated herein by reference in its entirety, it being further noted that foreign priority benefit is based upon Korean Patent Application No. 10-2021-0158507, filed Nov. 17, 2021, which is incorporated herein by reference in its entirety.

### TECHNICAL FIELD

The disclosure relates to a color panel, and more specifically, to a color panel applicable to a home appliance, a home appliance including the color panel, and a method for manufacturing the color panel.

### BACKGROUND ART

Home appliances such as refrigerators, clothes care apparatuses, dishwashers, and cooking apparatuses generally include a main body to contain an object to be treated and a door to open and close the main body.

For example, a refrigerator is an apparatus for keeping food fresh by including a main body including storage compartments and a cooling air supply system configured to supply cooling air to the storage compartments. The storage compartments include a refrigerating compartment maintained at a temperature of approximately 0° C. to 5° C. to keep food in a refrigerated state and a freezing compartment maintained at a temperature of approximately −30° C. to 0° C. to keep food in a frozen state. In general, a storage compartment is provided such that a front side is opened to put and take food into/out of the storage compartment, and the open front side of the storage compartment is closed by a door.

In either case where a home appliance is used or not used, the most often visible part to a user is a door or other panels defining the appearance. Accordingly, it is expected to improve aesthetic satisfaction of a user when a color of a panel is realized in accordance with a user's taste.

### DISCLOSURE

### Technical Problem

An aspect of the disclosure provides a color panel having a customized color, a home appliance including the color panel, and a method for manufacturing the color panel.

Another aspect of the disclosure provides a color panel that allows ink to be applied uniformly on a panel with a pattern formed on a front thereof, a home appliance including the color panel, and a method for manufacturing the color panel.

### Technical Solution

According to an embodiment of the disclosure, a home appliance can include: a main body having an opening; a door configured to open and close the opening; and a color panel on at least one of the main body or the door, the color panel including: a base panel including: a front surface, and an uneven pattern portion on the front surface, having upper sides, and lower sides that are a height difference from the upper sides, and a color layer on the uneven pattern portion and including: main ink dots having a main ink dot size, and sub ink dots having a sub ink dot size that is smaller than the main ink dot size, and at least one sub ink dot of the sub ink dots can be between each two adjacent main ink dots of the main ink dots, and at least some of the sub ink dots can be on at least one of a periphery of the upper sides or a periphery of the lower sides.

The uneven pattern portion can include an embossed pattern forming at least some of the upper sides and at least some of the lower sides, at least some of the sub ink dots can be on a periphery of the upper sides formed by the embossed pattern, and at least some of the plurality of sub ink dots can be on a periphery of the lower sides formed by the embossed pattern.

The home appliance can further include lateral sides between the upper sides and the lower sides and at least some of the lateral sides can connect the upper sides formed by the embossed pattern and the lower sides formed by the embossed pattern, and some of the sub ink dots can be on the lateral sides connected by the embossed pattern.

The uneven pattern portion can include an engraved pattern forming at least some of the upper sides and at least some of the lower sides, at least some of the sub ink dots can be on a periphery of the lower sides formed by the engraved pattern, and at least some of the sub ink dots can be on a periphery of the upper sides formed by the engraved pattern.

The home appliance can further include lateral sides between the upper sides and the lower sides and at least some of the lateral sides can connect the upper sides formed by the engraved pattern and the lower sides formed by the engraved pattern, and some of the sub ink dots can be on the lateral sides connected by the engraved pattern.

The height difference can be 30 micrometers or more.

The main ink dots and the sub ink dots can include a material that is curable by ultraviolet light.

The color panel can further include a transparent layer at least partially covering the color layer.

A shape of the transparent layer can correspond to a shape of the uneven pattern portion.

The transparent layer can include a transparent ink.

The base panel can further include a coating layer on the front surface, and the color layer can be on the coating layer.

The coating layer can have a white color.

A shape of the coating layer can correspond to a shape of the uneven pattern portion.

According to an embodiment of the disclosure, a method for manufacturing a color panel can include: receiving color information including main area location information about a plurality of main areas on an uneven pattern portion on a front surface of a base panel, and sub area location information about a plurality of sub areas on the uneven pattern portion, applying at least one main ink dot of a plurality of main ink dots on each main area of the plurality of main areas based on the main area location information and applying at least one sub ink dot of a plurality of sub ink dots on each sub area of the plurality of sub areas based on the sub area location information, to form a color layer on the base panel, wherein each main ink dot of the plurality of main ink dots has a main ink dot size, and each sub ink dot of the plurality of sub ink dots has a sub ink dot size that is smaller than the main ink dot size, and forming a transparent layer on the color layer.

The method can further include forming a coating layer on the front surface of the base panel, and the color layer may be formed on the coating layer.

The method can further include forming the uneven pattern portion on the front surface of the base panel, wherein at least some of the plurality of sub areas can be located on a periphery of the pattern portion.

The color layer can be formed by spraying the plurality of main ink dots and the plurality of sub ink dots by an inkjet spraying device and curing by ultraviolet light.

The transparent layer can be formed by printing a transparent ink and heat drying the transparent ink.

According to an embodiment of the disclosure, a color panel can include: a base panel, a color layer including a plurality of main ink dots applied on a front surface of the base panel and a plurality of sub ink dots applied between the plurality of main ink dots and having a smaller size than the main ink dots, at least a portion of the plurality of sub ink dots being applied on a periphery of a pattern portion, and a transparent layer that covers the color layer.

The base panel can further include a coating layer on the front surface of the base panel, and the color layer may be on the coating layer.

### Advantageous Effects

According to the disclosure, a home appliance with a panel in a color desired by a consumer may be provided, thereby improving aesthetic satisfaction of the consumer.

According to the disclosure, main ink dots and smaller sub ink dots may be applied to desired locations on a panel.

According to the disclosure, by applying main ink dots and smaller sub ink dots, ink may be applied evenly across a panel where a pattern is formed.

### DESCRIPTION OF DRAWINGS

FIG. 1 is an external view of a refrigerator, as an example of a home appliance according to an embodiment.

FIG. 2 is a view illustrating a door of the refrigerator illustrated in FIG. 1.

FIG. 3 is an external view of a clothes care apparatus, as another example of the home appliance according to an embodiment.

FIG. 4 is an external view of a dishwasher, as another example of the home appliance according to an embodiment.

FIG. 5 is an external view of a cooking apparatus, as another example of the home appliance according to an embodiment.

FIG. 6 is a side cross-sectional view of a color panel according to an embodiment.

FIG. 7 is a view illustrating a direction in which a color panel according to an embodiment is aligned in a home appliance.

FIG. 8 is a flowchart of a method for manufacturing a color panel according to an embodiment.

FIG. 9 is a flowchart of a method for manufacturing a color panel according to an embodiment further including an operation of forming a pattern portion.

FIG. 10 is a view illustrating an example of a method for forming a pattern portion of a color panel according to an embodiment.

FIG. 11 is a flowchart of a method for manufacturing a color panel according to an embodiment further including an operation of forming a coating layer.

FIG. 12 is a control block diagram of a digital printing device used to manufacture a color panel according to an embodiment.

FIG. 13 and FIG. 14 are views illustrating example processes of forming a color layer according to a method for manufacturing a color panel according to an embodiment.

FIG. 15 is a flowchart of a method for manufacturing a color panel according to an embodiment in which ink ejection and UV curing are simultaneously performed.

FIG. 16 and FIG. 17 are views for describing UV curing illustrated in FIG. 15.

FIG. 18 is a flowchart of a method for manufacturing a color panel according to an embodiment in which UV curing is performed after inks are ejected.

FIG. 19 and FIG. 20 are views for describing UV curing illustrated in FIG. 18.

FIG. 21 is a flowchart of a method for manufacturing a color panel according to an embodiment further including an operation of forming a transparent layer.

FIG. 22 is a side cross-sectional view of a color panel without a pattern according to another embodiment.

FIG. 23 is a side cross-sectional view of a color panel without a coating layer according to still another embodiment.

FIG. 24 is a control block diagram for describing a process of receiving color information to manufacture a color panel according to the embodiments of FIG. 1 to FIG. 23.

### MODES OF THE INVENTION

Embodiments described in the disclosure and configurations shown in the drawings are merely examples of the embodiments of the disclosure, and may be modified in various different ways at the time of filing of the present application to replace the embodiments and drawings of the disclosure.

Also, like reference numerals or symbols denoted in the drawings of the specification represent members or components that perform the substantially same functions.

Also, the terms used herein are used only to describe particular embodiments and are not intended to limit the disclosure. It is to be understood that the singular forms are intended to include the plural forms as well, unless the context clearly dictates otherwise. It is to be understood that the terms “include” and “have,” are intended to indicate the presence of the features, numbers, steps, operations, components, parts, or combinations thereof disclosed in the disclosure, but do not preclude the presence or addition of one or more other elements.

Also, it is to be understood that, although the terms including ordinal numbers, such as “first”, “second”, etc., may be used herein to describe various components, these components should not be limited by these terms. These terms are only used to distinguish one component from another. For example, a first component could be termed a second component, and, similarly, a second component could be termed a first component, without departing from the scope of the disclosure. As used herein, the term “and/or” includes any and all combinations of one or more of associated listed items.

Also, terminology such as “at least one of A and B” or “at least one of A or B”, as used herein, includes any of the following: A, B, A and B.

Also, terminology such as “at least one of A, B, and C” or “at least one of A, B, or C”, as used herein, includes any of the following: A, B, C, A and B, A and C, B and C, A and B and C.

In addition, hereinafter, for convenience of description, a home appliance is described as an example of a type of product to which a color panel is applied, but the configuration of the disclosure is not limited to a panel of the home appliance and may be applied to various products such as automobiles and display devices. Furthermore, in the following, the color panel is described as a panel made of steel plate, but the configuration of the disclosure is not limited thereto and may be applied to panels made of various materials such as plastic resin panels.

Hereinafter, embodiments of the disclosure are described in detail with reference to the accompanying drawings.

The home appliance according to an embodiment may be at least one of various home appliances such as a refrigerator, a clothes care apparatus, a dishwasher, and a cooking apparatus. Hereinafter, some examples of the home appliance according to an embodiment are described.

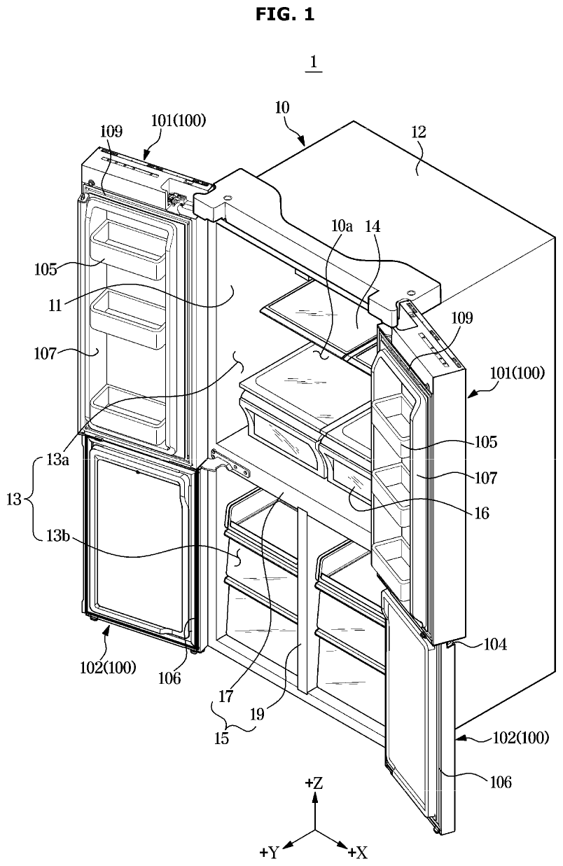

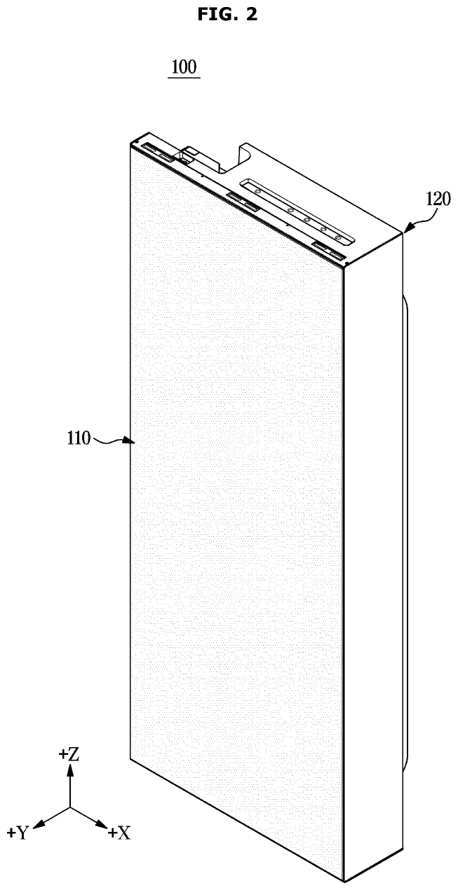

FIG. 1 is an external view of a refrigerator, as an example of a home appliance according to an embodiment. FIG. 2 is a view illustrating a door of the refrigerator illustrated in FIG. 1.

In the embodiment to be described below, directions defined by X-axis, Y-axis, and Z-axis are described relative to the home appliance. A width direction of the home appliance is defined as the X-axis, a depth direction is defined as the Y-axis, and a height direction is defined as the Z-axis. In addition, an outward direction of a main body opening 10a is defined as +Y direction and an inward direction is defined as −Y direction.

Meanwhile, forward and backward direction of the home appliance may be defined by arrangement of the home appliance or a position relative to a consumer or user. In the embodiment, a consumer who purchases and uses a home appliance is defined as a user.

When a refrigerator 1 is arranged as shown in FIG. 1, a user generally sees the main body opening 10a (in a state where the door is opened) or door 100 (in a state where the door is closed), the +Y direction where the user is located relative to the refrigerator 1 may be defined as a forward direction and the −Y direction may be defined as a backward direction.

Referring to FIG. 1, the refrigerator 1 includes a main body 10, a storage compartment 13 divided into upper and lower storage compartments in the main body 10, a door 100 configured to open and close the storage compartment 13, and a cooling air supply device (not shown) configured to supply cooling air to the storage compartment 13.

The main body 10 may include an inner cabinet 11 defining the storage compartment 13, an outer cabinet 12 coupled to outer sides of the inner cabinet 11 to define an appearance, and a main body insulation material (not shown) disposed between the inner cabinet and the outer cabinet to insulate the storage compartment 13.

The cooling air supply device may generate cooling air by using a cooling circulation cycle of compressing, condensing, expanding, and evaporating a refrigerant.

The storage compartment 13 may be divided into a plurality of regions by a partition 15, and a plurality of shelves 14 and storage containers 16 may be provided in the storage compartment 13 to store foods, or the like.

The storage compartment 13 may be divided into a plurality of storage compartments 13a and 13b by the partition 15, and the partition 15 includes a first partition 17 arranged in a horizontal direction to vertically divide an interior of the storage compartment 13, and a second partition 19 arranged in a longitudinal direction to horizontally divide the interior of the storage compartment 13.

The above-described division of the storage compartment 13 is an example, and the storage compartment 13 may also be divided in any manner other than the above-described example.

The storage compartment 13 may be opened or closed by the door 100. The door 100 may include a pair of first doors (or upper doors) 101 to open and close an upper storage compartment 13a and a pair of second doors (or lower doors) 102 to open and close a lower storage compartment 13b.

The pair of the first doors 101 and the pair of second door 102 may open and close the main body opening 10a of the open main body 10. Handles may be provided at the first door 101 and the second door 102, and a user may open the first door 101 and the second door 102 using the handles respectively provided at the first door 101 and the second door 102.

Door shelves 105 to store foods may be provided at a rear surface of the first door 101. The door shelves 105 may include shelve supports 107 extending in a direction perpendicular to the first door 101 to support the door shelves 105 at both sides of each door shelf 105. The shelve supports 107 may be detachably provided to the first doors 101 as separate components, and in the embodiment, the shelve supports 107 are provided to vertically extend in a form protruding from the rear surfaces of the first door 101.

A first gasket 109 may be provided on a rim of the rear surface of the first door 101 to seal a gap between the first doors 101 and the main body 10 when the first door 101 is closed. The first gasket 109 may be provided in a loop shape along the rim of the rear surface of the first door 101 and may include a first magnet (not shown).

The lower storage compartment 13b may be opened and closed by the second doors 102 pivotally coupled to the main body 10. A second gasket 106 may be provided on a rim of the rear surface of the second door 102 to seal a gap between the second door 102 and the main body 10 when the second door 102 is closed. The second gasket 106 may be provided in a loop shape along the rim of the rear surface of the second door 102 and may include a second magnet (not shown).

Referring to FIG. 2, the door 100 may include a door panel 110 and a door body 120. The door panel 110 may be detachably coupled to the door body 120. The door 100 shown in FIG. 2 is one of a pair of upper doors 101.

The door panel 110 may be provided on a front side of the door 100, and the door body 120 may be provided on a rear side of the door 100, i.e., to face the inside of the main body 10. The front side of the door 100 may refer to a side shown to a user when the door 100 is closed. The rear side of the door 100 may refer to a side facing the storage compartment 13 when the door 100 is closed.

The door body 120 provided on the rear side of the door 100 may include various components to define an appearance of the door 100 such as a chassis, a door cap, a cover, and a case and components to seal the storage compartment 13 in the main body 10 from the outside.

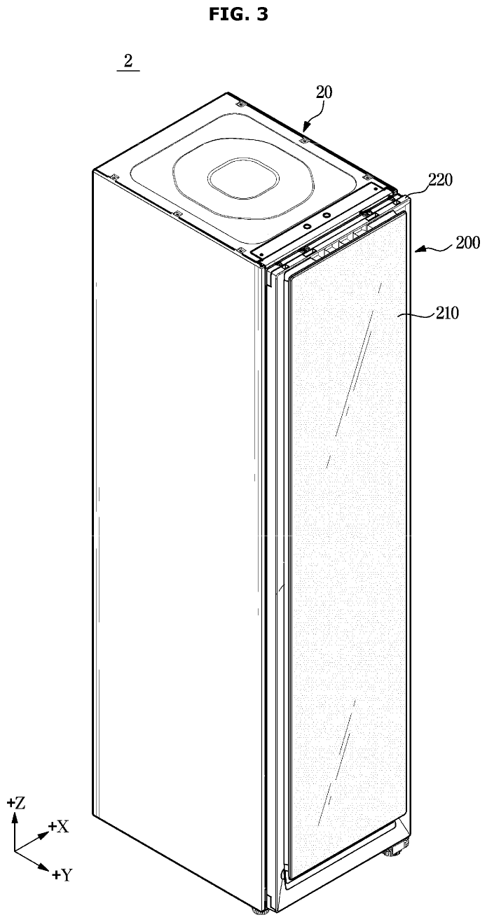

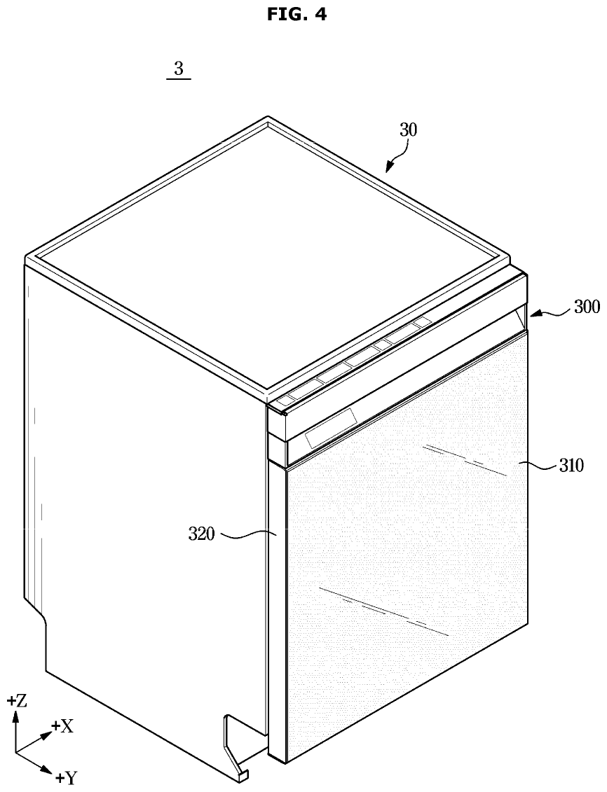

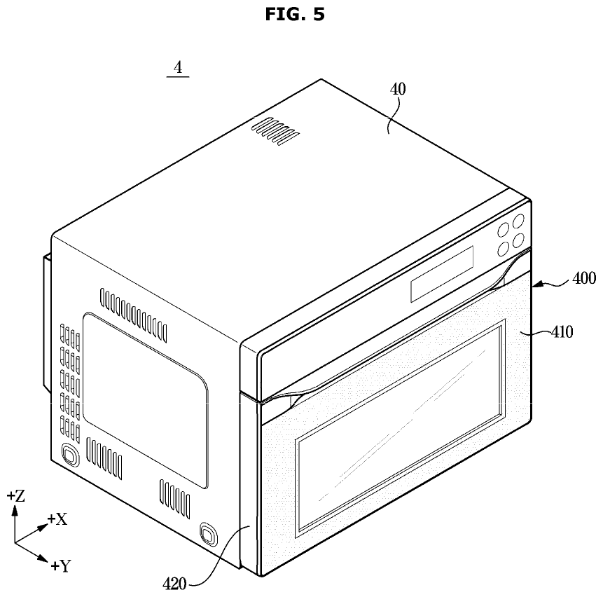

FIG. 3 is an external view of a clothes care apparatus, as another example of the home appliance according to an embodiment, FIG. 4 is an external view of a dishwasher, as another example of the home appliance according to an embodiment, and FIG. 5 is an external view of a cooking apparatus, as another example of the home appliance according to an embodiment.

Referring to FIG. 3, a clothes care apparatus 2 may include a main body 20 defining an appearance and a door 200 pivotally coupled to the main body 20. The clothes care apparatus 2 may include a clothes care chamber disposed in the main body 20 to accommodate clothes, a clothes support member (not shown) disposed inside the clothes care chamber and configured to mount clothes, and a machine room (not shown) including a heat exchanger (not shown) to dehumidify or heat the air inside the clothes care chamber.

The door 200 may open and close the clothes care chamber provided inside the main body 20. The door 200 may include a door panel 210 and a door body 220, and the door panel 210 may be detachably coupled to the door body 220. As shown in FIG. 3, the door panel 210 may be provided on a front side of the door 200, and the door body 220 may be provided on a rear side of the door 200. The front side of the door 200 refers to a side shown to a user when the door 200 is closed. The rear side of the door 200 refers to a side facing the inside of the main body 20 when the door 200 is closed.

Referring to FIG. 4, a dishwasher 3 may include a main body 30 defining an appearance and a door 300 pivotally coupled to the main body 30.

A washing chamber (not shown) to contain dishes may be provided in the main body 30. The dishwasher 3 may include various components such as a plurality of nozzles to wash dishes in the washing chamber, a driving device for driving the plurality of nozzles, and a controller for controlling the driving device. The door 300 may open and close the washing chamber disposed inside the main body 30.

The door 300 may include a door panel 310 and a door body 320, and the door panel 310 may be detachably coupled to the door body 320. As shown in FIG. 4, the door panel 310 may be provided on a front side of the door 300, and the door body 320 may be provided on a rear side of the door 300. The front side of the door 300 refers to a side shown to a user when the door 300 is closed. The rear side of the door 300 refers to a side facing the inside of the main body 30 when the door 300 is closed.

Referring to FIG. 5, a cooking apparatus 4 may include a main body 40 defining an appearance and a door 400 pivotally coupled to the main body 40.

A cooking chamber (not shown) to contain food ingredients may be provided in the main body 40, and the cooking apparatus 4 may include various components such as a heater, a heating wire, a fan, and a controller for heating and cooking food ingredients contained in the cooking chamber.

The door 400 may open and close the cooking chamber disposed in the main body 40. The door 400 may include a door panel 410 and a door body 420, and the door panel 410 may be detachably coupled to the door body 420. As shown in FIG. 5, the door panel 410 may be provided on a front side of the door 400, and the door body 420 may be provided on a rear side of the door 400. The front side of the door 400 refers to a side shown to a user when the door 400 is closed. The rear side of the door 400 refers to a side facing the inside of the main body 40 when the door 400 is closed.

Although an oven is described as an example of the cooking apparatus 4 in the embodiment, an induction range for heating a cooking container positioned on a plate by magnetic induction may also be included as the cooking apparatus 4. In a case where the cooking apparatus 4 is implemented as an induction range, a color panel 500 may be applied to a control panel or a plate provided with a user interface.

All of the home appliances 1, 2, 3 and 4 according to the above-described embodiments include the doors 100, 200, 300 and 400 used to open and close interior space of the main bodies 10, 20, 30 and 40, and the doors 100, 200, 300 and 400 include the door panels 110, 210, 310 and 410 defining the appearances thereof, respectively. That is, the door panels 110, 210, 310 and 410 are shown to a user in a state where the doors 100, 200, 300 and 400 are closed.

When the home appliances 1, 2, 3 and 4 are not in use, the doors 100, 200, 300 and 400 are closed, and a user requires to approach and open the doors 100, 200, 300 and 400 to use the home appliances 1, 2, 3 and 4. Accordingly, it may be seen that the door panels 110, 210, 310 and 410 are one of the parts affecting aesthetic satisfaction of a user.

As a factor capable of improving aesthetic satisfaction of a user without affecting the functions of the doors 100, 200, 300 and 400, color of the door panels 110, 210, 310 and 410 may be used. Accordingly, when the door panels 110, 210, 310 and 410 are implemented in a color desired by the user, the user's aesthetic satisfaction with the home appliances 1, 2, 3 and 4 may be improved.

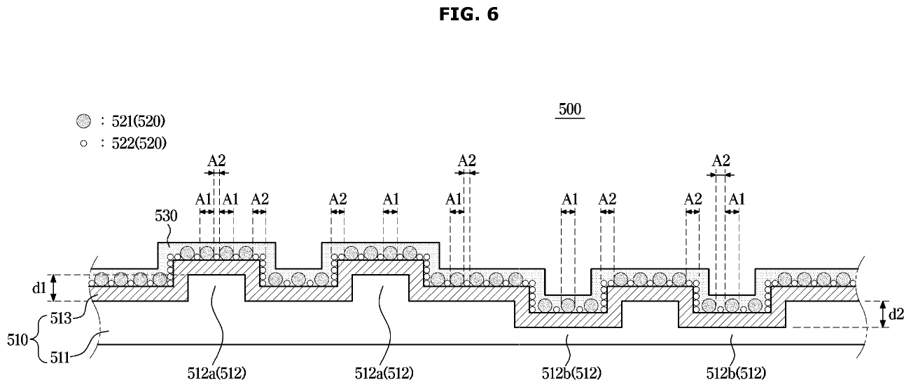

To this end, the color panel 500 (see FIG. 6) according to an embodiment to be described below may be used as the door panels 110, 210, 310 and 410 of the home appliances 1, 2, 3 and 4.

Meanwhile, the above-described home appliances are merely examples of the home appliance according to an embodiment. Accordingly, in addition to the above-described home appliances, any home appliances including the color panel 500 to be described below may also be included in the embodiments of the disclosure.

In addition, the color panel 500 is not necessarily used only as the door panel. The color panel 500 may also be used as a panel included in the main bodies 10, 20, 30 and 40, or the color panel 500 may be used as any panel defining the appearance of the home appliance and shown to the user as well as the main bodies 10, 20, 30 and 40.

Hereinafter, the color panel 500 and a method for manufacturing the same according to an embodiment of the disclosure are described in detail.

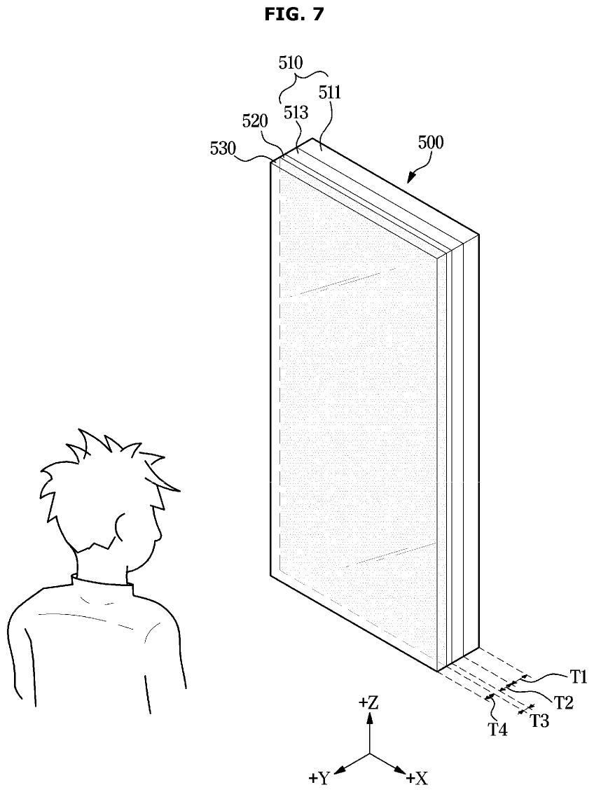

FIG. 6 is a side cross-sectional view of a color panel according to an embodiment. FIG. 7 is a view illustrating a direction in which a color panel according to an embodiment is aligned in a home appliance.

Referring to FIG. 6 and FIG. 7, the color panel 500 may include a base panel 510 and a color layer 520 formed on a front surface of the base panel 510.

The base panel 510 may be included in at least one of the main body 10, 20, 30 and 40 or the door 100, 200, 300 and 400 of the home appliance 1, 2, 3 and 4. The base panel 510 may be required to have predetermined physical and chemical properties to form a panel of the main body 10, 20, 30 and 40 or the door 100, 200, 300 and 400. For example, the base panel 510 may require a predetermined level of rigidity or heat resistance.

The base panel 510 may include a metal material. Specifically, the base panel 510 may include a steel plate material. Accordingly, the base panel 510 may have properties such as sufficient rigidity, and a pattern portion 512, to be described later, may be easily formed on the base panel 510. However, the disclosure is not limited thereto, and the base panel 510 may include various materials. For example, the base panel 510 may include a plastic resin material.

The base panel 510 may include a base 511 and a coating layer 513 formed on the base 511. Specifically, as described above, the base 511 may be required to have physical and chemical properties such as rigidity or heat resistance above a predetermined level, and in particular, may include a metal material such as a steel plate material. The coating layer 513 may be applied on a front surface of the base 511, and specifically may be applied on the front surface of the base 511 by including ink.

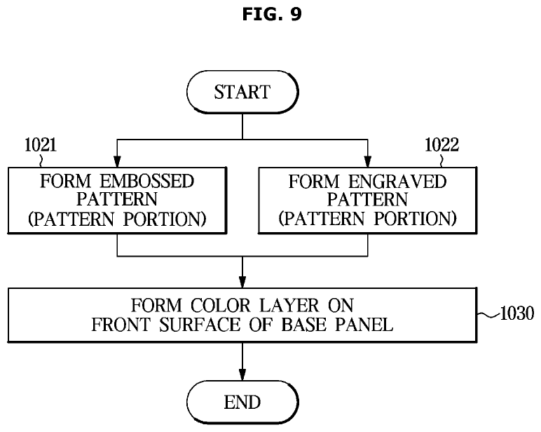

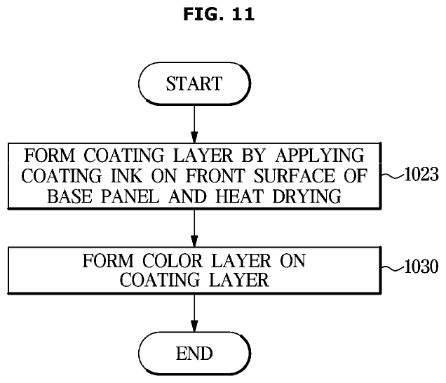

The base panel 510 may include the pattern portion 512 that forms unevenness on the front surface of the base panel 510. Specifically, the pattern portion 512 may be formed on the base 511, and may be formed before the coating layer 513 is applied on the base 511. However, the disclosure is not limited thereto, and forming the pattern portion 512 on the base 511 (1021, 1022, see FIG. 9) may be performed after applying the coating layer 513 on the base 511 (1023, see FIG. 11).

The pattern portion 512 may be formed to include at least one of an embossed pattern 512a or an engraved pattern 512b. A variety of methods for forming the embossed pattern 512a or the engraved pattern 512b may be used. For example, the embossed pattern 512a may be formed through a press process, and the engraved pattern 512b may be formed through an etching process. The process of forming the embossed pattern 512a or the engraved pattern 512b will be described later.

Although it is illustrated in FIG. 6 that the pattern portion 512 formed on the base panel 510 includes both the embossed pattern 512a and the engraved pattern 512b, the pattern portion 512 is not limited thereto. For example, only the embossed pattern 512a or the engraved pattern 512b may be formed on the base panel 510.

To improve a texture effect of the material that may be perceived by a user due to the unevenness of the pattern portion 512, a predetermined level of height difference between upper and lower sides of the pattern portion 512 may be implemented.

Referring to FIG. 6, a height difference between upper and lower sides of the embossed pattern 512a may be referred to as d1, and a height difference between upper and lower sides of the engraved pattern 512b may be referred to as d2. In this instance, d1 or d2 may be 30 micrometers (m) or more. However, the disclosure is not limited thereto, and the upper and lower sides of the pattern portion 512 may be formed to have various height differences.

Because the pattern portion 512 is formed on the base panel 510, a three-dimensional texture may be perceived by a consumer. Meanwhile, without forming the pattern portion 512 on the base panel 510, a three-dimensional texture may be conveyed to a consumer by applying a plurality of ink layers on the front surface of the base panel 510 to form unevenness by the ink layers. However, in a case where unevenness is formed by applying the plurality of ink layers, damage such as cracks may occur in the plurality of ink layers during a bending process of the color panel 500. Accordingly, by forming the pattern portion 512 on the base panel 510 and then applying inks 521 and 522 along the pattern portion 512 to form the color layer 520, damage to the color layer 520 during bending may be reduced.

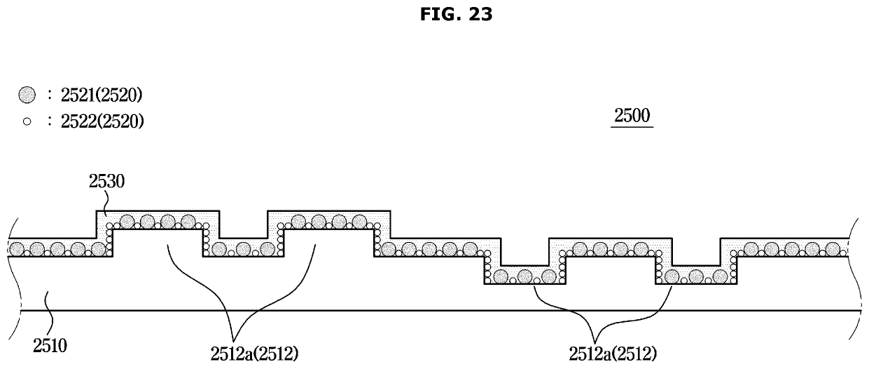

The coating layer 513 may include a material with a high bonding strength between the inks 521 and 522, which will be described later, to facilitate bonding between the inks 521 and 522 and the base panel 510 when the inks 521 and 522 of the color layer 520 are applied on the base panel 510. Accordingly, the color layer 520 may be stably formed on the base panel 510. However, the disclosure is not limited thereto, and the coating layer 513 may not be applied on the base panel 510 as in the embodiment of FIG. 23. Instead, for example, the base panel 510 may be formed to increase a bonding strength with the inks 521 and 522 through plasma heat treatment, and thus the color layer 520 may be stably formed on the base panel 510.

The coating layer 513 may be formed to have a predetermined color to allow a user to easily determine a color of the color layer 520 to be formed on the base panel 510. Specifically, the coating layer 513 may have a white-based color. In this case, the white-based color of the coating layer 513 serves as a base for the color layer 520, and thus the same effect as color printed on white paper may be obtained.

Furthermore, in a case where the coating layer 513 has a white-based color, when a user purchases the home appliance 1, 2, 3 or 4, the color of the color panel 500 may be identified via a computer, a mobile device, or a display provided in a digital signage or a kiosk installed in a store. Because the color output through the display is also a color displayed on a white background, a visual color difference between the color identified by a user through the display and a real color of the color panel 500 may be minimized by arranging the white coating layer 513 behind the color layer 520.

As an example for implementing the above-described effect, the white-based color of the coating layer 513 may satisfy L*=90 to 100, a*=−5.0 to 5.0, and b*=−5 to 5 in a CIE LAB color space (L* for brightness, and a* and b* for chromaticity indicating color and chroma). In addition, a visible light transmittance of the white-based color of the coating layer 513 may be limited to 10% or less. However, the disclosure is not limited thereto, and the coating layer 513 may be formed to have various colors. In a case where the coating layer 513 does not have a white-based color or the base panel 510 does not include the coating layer 513, a separate white-based color layer (not shown) may be included in the color layer 520 when forming the color layer 520, in order to have an effect of the coating layer 513 having the white-based color as described above.

The coating layer 513 may be formed to include a shape corresponding to the unevenness of the pattern portion 512. Accordingly, even though the coating layer 513 is applied on the base 511 on which the pattern portion 512 is formed, a visual effect due to the height difference between the upper and lower sides of the pattern portion 512 may not be reduced.

A method of forming the coating layer 513 on the front surface of the base panel 510 will be described in detail later (1023, see FIG. 11).

The color layer 520 may be formed on the front surface of the base panel 510. The color layer 520 may be formed including the inks 521 and 522, and specifically, the color layer 520 may be formed by spraying (ejecting) the ink dots 521 and 522 on the front surface of the base panel 510.

The color layer 520 may include the plurality of main ink dots 521 and the plurality of sub ink dots 522 having a size smaller than the main ink dots 521.

On the front surface of the base panel 510, areas where the plurality of main ink dots 521 are applied may be defined as a plurality of main areas A1, and areas where the plurality of sub ink dots 522 are applied may be defined as a plurality of sub areas A2. The plurality of sub areas A2 may be distinguished from the plurality of main areas A1.

The plurality of main areas A1 and the plurality of sub areas A2 may be distinguished by various criteria. For example, as shown in FIG. 6, the plurality of sub areas A2 may be arranged between the plurality of main areas A1. In particular, in a case where the base panel 510 includes the pattern portion 512, at least a portion of the plurality of sub areas A2 may be arranged on a periphery of the pattern portion 512. In other words, the plurality of sub ink dots 522 may be applied between the plurality of main ink dots 521, and at least a portion of the plurality of sub ink dots 522 may be applied on the periphery of the pattern portion 512.

In a case where the color layer 520 includes only the plurality of main ink dots 521, each of the main ink dots 521 is large in size, and thus an area where ink is not sufficiently applied may occur between the plurality of main ink dots 521 on the base panel 510. In particular, on the periphery of the pattern portion 512, an area where the main ink dots 521 are not applied may occur due to the size of the main ink dot 521. That is, in a case where the color layer 520 includes only the plurality of main ink dots 521, an unpainted area (not shown) where the main ink dots 521 may not be applied may occur, including the area on the periphery of the pattern portion 512.

By contrast, in a case where the color layer 520 includes only the plurality of sub ink dots 522 without the plurality of main ink dots 521, each of the sub ink dots 522 is small in size, and thus it takes a long time to form the color layer 520 on the base panel 510, which may reduce productivity.

To overcome the above, in forming the color layer 520 on the base panel 510, the plurality of main ink dots 521 may be applied overall on the front surface of the base panel 510, and the plurality of sub ink dots 522 may be applied in areas between the plurality of main ink dots 521 and on the periphery of the pattern portion 512 on which the plurality of main ink dots 521 are not sufficiently applied. In other words, the plurality of main areas A1 may be formed on the front surface of the base panel 510, the plurality of sub areas A2 may be formed between the plurality of main areas A1, and at least a portion of the plurality of sub areas A2 may be formed on the periphery of the pattern portion 512. Furthermore, the plurality of sub ink dots 522 may be applied to the unpainted areas other than the periphery area of the pattern portion 512. Accordingly, the color layer 520 may be evenly formed on the front surface of the base panel 510.

In a case where the pattern portion 512 on the base panel 510 includes the embossed pattern 512a, at least a portion of the plurality of sub ink dots 522 may be applied along a periphery of an upper surface of the embossed pattern 512a. At least another portion of the plurality of sub ink dots 522 may be applied along a periphery of a lower portion of the embossed pattern 512a. In other words, at least a portion of the plurality of sub areas A2 may be formed on the periphery of the upper surface of the embossed pattern 512a, and at least another portion of the plurality of sub areas A2 may be formed on the periphery of the lower portion of the embossed pattern 512a.

In addition, at least another portion of the plurality of sub ink dots 522 may be applied on a lateral side of the embossed pattern 512a. In a case where the lateral side of the embossed pattern 512a is formed perpendicular to the base 511 as shown in FIG. 6, at least a portion of the plurality of sub ink dots 522 applied on the lateral side of the embossed pattern 512a may be applied in a layered manner. However, the disclosure is not limited thereto, and the plurality of sub ink dots 522 may be arranged in various manners on the periphery of the embossed pattern 512a.

In a case where the pattern portion 512 on the base panel 510 includes the engraved pattern 512b, at least a portion of the plurality of sub ink dots 522 may be applied along a periphery of a bottom surface of the engraved pattern 512b. At least another portion of the plurality of sub ink dots 522 may be applied along a periphery of an upper portion of the engraved pattern 512b. In other words, at least a portion of the plurality of sub areas A2 may be formed on the periphery of the bottom surface of the engraved pattern 512b, and at least another portion of the plurality of sub areas A2 may be formed on the periphery of the upper portion of the engraved pattern 512b.

In addition, at least another portion of the plurality of sub ink dots 522 may be applied on a lateral side of the engraved pattern 512b. In a case where the lateral side of the engraved pattern 512b is formed perpendicular to the base 511 as shown in FIG. 6, at least a portion of the plurality of sub ink dots 522 applied on the lateral side of the engraved pattern 512b may be applied in a layered manner. However, the disclosure is not limited thereto, and the plurality of sub ink dots 522 may be arranged in various manners on the periphery of the engraved pattern 512b.

However, the disclosure is not limited thereto, and the plurality of main ink dots 521 and the plurality of sub ink dots 522 may be applied in various manners on the front surface of the base panel 510. Depending on a surface shape of the base panel 510 and a color or shape (type) of the color layer 520 that a user desires to apply on the base panel 510, the plurality of main ink dots 521 and the plurality of sub ink dots 522 may be applied in various manners on the front surface of the base panel 510. In other words, the plurality of main areas A1 and the plurality of sub areas A2 may be formed in various manners on the front surface of the base panel 510 depending on a type of the color layer 520 set by the user. For example, when attempting to form a finer color layer 520 on the base panel 510, a user may set corresponding locations as the plurality of sub areas A2 regardless of the shape of the base panel 510 such as the arrangement of the pattern portion 512, and the plurality of sub ink dots 522 may be applied.

The main ink dot 521 may have a volume of approximately 12 pl (picoliter). The sub ink dot 522 may have a volume of 3 pl, which is smaller than the main ink dot 521. However, the disclosure is not limited thereto, and the main ink dot 521 and the sub ink dot 522 may be formed to have various sizes as long as the size of the main ink dot 521 is larger than that of the sub ink dot 522. Furthermore, the ink dots 521 and 522 may have not only two sizes as shown in FIG. 6, but have three or more sizes.

The color panel 500 may further include a transparent layer 530 covering the color layer 520. The transparent layer 530 may be made of a transparent material to allow a user to see the color layer 520 through the transparent layer 530.

The transparent layer 530 may include a material having a hardness greater than that of the material of the color layer 520. Accordingly, the transparent layer 530 may protect the color layer 520 without blocking the color of the color layer 520.

The transparent layer 530 may include a material having similar physical and chemical properties to the color layer 520, so as to be effectively bonded to the color layer 520. In addition, the transparent layer 530 may include a material having similar heat resistance to the color layer 520 to prevent the color layer 520 from being damaged while forming the transparent layer 530 on the color layer 520.

The transparent layer 530 may include transparent ink. Specifically, the transparent layer 530 may include transparent ink made of a plastic resin material. For example, the transparent ink of the transparent layer 530 may include a polyester resin material. However, the disclosure is not limited thereto, and the transparent layer 530 may include various materials that may provide the above-described functions and properties of the transparent layer 530.

The transparent layer 530 may be formed to include a shape corresponding to the unevenness of the pattern portion 512. Accordingly, a texture of the color panel 500 perceived by a user due to the unevenness of the pattern portion 512 may not be distorted by the transparent layer 530. However, the disclosure is not limited thereto, and the transparent layer 530 may have various shapes. Because the transparent layer 530 is made of a transparent material, the texture caused by the pattern portion 512 may not be significantly distorted even when an upper surface of the transparent layer 530 is formed in a horizontal shape.

As shown in FIG. 7, when the color panel 500 of the above configuration is used in the home appliances 1, 2, 3 and 4, the base panel 510 including the base 511 and the coating layer 513 may be arranged at a rear (−Y direction) of the home appliances 1, 2, 3 and 4. Based on the base 511 of the base panel 510, the coating layer 513, the color layer 520, and the transparent layer 530 may be sequentially arranged in a forward direction (+Y direction) of the base 511.

A user looks at the color panel 500 in front of the transparent layer 530, and may recognize the color of the color layer 520 arranged behind the transparent layer 530 as the color of the color panel 500. Also, the user may perceive a three-dimensional effect or texture of the color panel 500 differently depending on the shape of the pattern portion 512 of the base panel 510 arranged behind the color layer 520.

A thickness T1 of the base 511 may be approximately 1 mm (millimeter) to 2 mm. As described above, the height differences d1 and d2 between the upper and lower sides of the pattern portion 512 may be 30 μm (micrometer) or more. A thickness T2 of the coating layer 513 may be approximately 10 μm or less. A thickness T3 of the color layer 520 may be approximately 1 μm or less. A thickness T4 of the transparent layer 530 may be approximately 10 μm or less, and preferably 5 μm or less. However, the disclosure is not limited thereto, and each of the components 510, 520, and 530 included in the color panel 500 may be formed to have various thicknesses T1, T2, T3, and T4 depending on the purpose of the color panel 500.

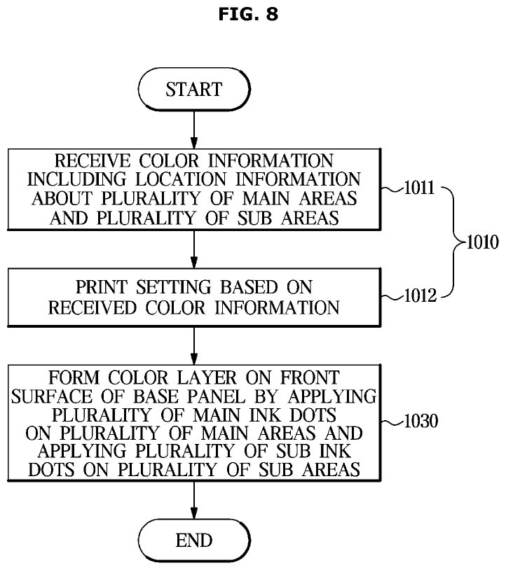

FIG. 8 is a flowchart of a method for manufacturing a color panel according to an embodiment.

An operation (1010) of receiving color information (1011) and print-setting (1012) before applying the color layer 520 may be included in manufacturing the color panel 500. The color information may include location information about the plurality of main areas A1 and location information about the plurality of sub areas A2 on a front surface of the base panel 510, in order to set positions where the plurality of main ink dots 521 and the plurality of sub ink dots 522 are applied. The color information may include information about colors, sizes, and the like of the plurality of main ink dots 521 to be applied on the plurality of main areas A1 and information about colors, sizes, and the like of the plurality of sub ink dots 522 to be applied on the plurality of sub areas A2. The color layer 520 may be formed (1030) by applying the ink dots 521 and 522 on the front surface of the base panel 510 based on the color information including the above-described information.

The color layer 520 may be formed by digital printing. In the embodiment, digital printing is a printing method that contrasts with screen printing (or silk screen printing).

Screen printing is a printing technique where a desired color is printed on an object to be printed, by disposing a screen formed of silk, or the like, on the object to be printed, applying a pre-mixed ink to the screen, squeezing and drying the applied ink. The screen printing is suitable for mass production of small items because the ink requires to be mixed in advance.

In a case where color information according to the CMYK color system or the RGB color system is input to a digital printing device such as an inkjet printer or a laser printer, a desired color may be printed onto an object to be printed by spraying inks or toners respectively having cyan, magenta, yellow, and black colors through a plurality of nozzles of the digital printing device. The type of inks may vary in accordance with the color system used in the digital printing device. Digital printing is a printing technique using such a digital printing device.

In the method for manufacturing the color panel 500 according to an embodiment, a digital printing device is used to form the color layer 520. In a case where the digital printing device is used, inks or toners are not required to be mixed in advance because a plurality of color inks or toners are sprayed in an appropriate ratio in accordance with input color information each time printing is performed. Also, because the color information may be changed each printing process, various colors may be easily printed and high productivity may be obtained even when printing is performed in a small amount.

Accordingly, even though the color panel 500 having an ordered color may be produced in an ordered quantity each time an order for the color panel 500 is received, high productivity may be maintained.

In the following embodiments, an inkjet printer is described as an example of the digital printing device for detailed description.

Inks used in inkjet printers are liquids including a solvent, a pigment, a binder, and other additives. The pigment adheres to a surface of an object to be printed by the binder, and fluidity, surface energy, plasticization of the binder, and the like may be adjusted by the additives.

For stable adhesion of the ink onto the surface of the object to be printed, the surface requires to have a predetermined degree of printability or more and the printability is determined by factors such as surface tension, roughness, and porosity of the surface.

The configuration and operation of the digital printing device for forming the color layer 520 will be described later.

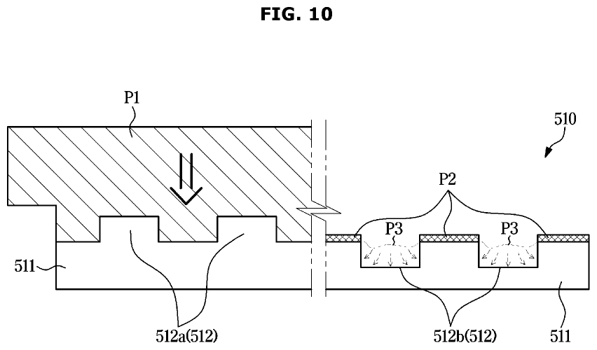

FIG. 9 is a flowchart of a method for manufacturing a color panel according to an embodiment further including an operation of forming a pattern portion. FIG. 10 is a view illustrating an example of a method for forming a pattern portion of a color panel according to an embodiment.

In forming the pattern portion 512 that forms unevenness on the front surface of the base panel 510 of the color panel 500, at least one of forming the embossed pattern 512a (1021) or forming the engraved pattern 512b (1022) may be included. The color layer 520 may be formed (1030) on the front surface of the base panel 510 on which the pattern portion 512 is formed.

Hereinafter, referring to FIG. 10, the operations 1021 and 1022 of forming the pattern portion 512 on the front surface of the base panel 510 are described in detail.

The operation of forming the embossed pattern 512a (1021) may include pressing the front surface of the base 511 using a press device P1 to form the embossed pattern 512a. In a case where the base 511 includes a steel plate material, in order to facilitate press processing, the operation of forming the embossed pattern 512a (1021) may include first heating the base 511, pressing the base 511 using the press device P1 to form the embossed pattern 512a, and cooling the base 511.

The operation of forming the engraved pattern 512b (1022) may include etching the front surface of the base 511 using an etching material P3. Specifically, positions for forming the engraved pattern 512b may be set on the base 511, an etching mask P2 may cover areas on the front surface of the base 511 where the engraved pattern 512b is not to be formed, and then the etching material P3 may be poured to etch the front surface of the base 511. The etching material P3 may be an etching solution such as ferric sulfate, hydrochloric acid, sulfuric acid, or nitric acid. The etching mask P2 may be a Polyvinyl Chloride (PVC) film with low reactivity with the etching material P3. In addition to the above, the etching mask P2 and the etching material P3 may include various materials.

The method of forming the pattern portion 512 on the front surface of the base panel 510 is not limited the above-described operations (1021 and 1022), and the pattern portion 512 may be formed in various manners depending on the shape of the pattern portion 512. For example, the engraved pattern 512b may also be formed by the press processing using the press device P1. Alternatively, in a case where the base 511 includes a plastic material, the pattern portion 512 may be formed through a plastic injection process.

As described above, the color layer 520 may be formed on the front surface of the base panel 510 on which the pattern portion 512 is formed (1030). Furthermore, the coating layer 513 may be formed on the pattern portion 512, and then the color layer 513 may be formed on the coating layer 513.

FIG. 11 is a flowchart of a method for manufacturing a color panel according to an embodiment further including an operation of forming a coating layer.

The method for manufacturing the color panel 500 may include forming the coating layer 513 on the front surface of the base panel 510 (1023) and forming the color layer 520 on the coating layer 513 (1030).

Forming the coating layer 513 (1023) may include applying coating ink on the base 511. Specifically, the operation of forming the coating layer 513 (1023) may include a silk screen printing process of applying coating ink on the base 511 and heat drying the applied coating ink. In this case, the coating layer 513 may be formed faster, compared to forming the coating layer 513 by digital printing, and productivity may be improved. However, the disclosure is not limited thereto, and the coating layer 513 may be formed using digital printing. As described above, the coating ink may have a white-based color.

The base panel 510 on which the coating layer 513 is formed may be referred to as a Pre-Coated (PCM) material.

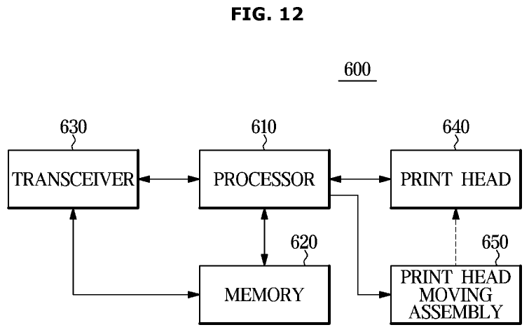

FIG. 12 is a control block diagram of a digital printing device used to manufacture a color panel according to an embodiment.

Referring to FIG. 12, a digital printing device 600 includes a transceiver 630 for receiving printing data, a memory 620 for storing the received printing data, a processor 610 for performing print setting based on the printing data, a print head 640 for ejecting (spraying) the inks 521 and 522 through a plurality of nozzles, and a print head moving assembly 650 for moving the print head 640.

For example, types of the inks 521 and 522 ejected through the plurality of nozzles may include cyan ink, magenta ink, yellow ink, and black ink. However, some inks may be added or omitted, if required. For example, white ink or transparent ink may further be added and black ink may be omitted.

A method for manufacturing a color panel according to an embodiment may include receiving color information by the digital printing device 600 (1011, refer to FIG. 8). The printing data received by the transceiver 630 may include color information.

According to an embodiment of the color panel 500, the color layer 520 may be implemented by a solid color or an image having various colors. Here, the image may include text. In a case where the color layer 520 is implemented as an image, the color information may include image information, and the digital printing device 600 may form an image corresponding to the received image information on the base panel 510.

The color information may be received in a form of a color code corresponding to a color selected by a consumer. However, types of the printing data received by the digital printing device 600 are not limited thereto, and any information indicating CMYK values or RGB values may also be used as color information received by the digital printing device 600 regardless of the types.

In addition, the received color information may be color information defined by the same color system as that applied to the digital printing device 600 or a color system different therefrom. For example, in a case where the digital printing device 600 employs the CMYK color system, the received color information may be color information indicating CMYK values or color information indicating RGB values. In the latter case, the processor 610 may convert the color information indicating the RGB values into color information corresponding to the CMYK color system.

In addition, the color information may include location information about the plurality of main areas A1 and the plurality of sub areas A2, as described above.

Print setting is performed based on the received color information (1012, refer to FIG. 8). The processor 610 may perform various data processing or data conversion to perform printing based on the received color information, and such operations are referred to as ‘print setting’ in the embodiment.

For example, the processor 610 may determine concentration data of the cyan ink, the magenta ink, the yellow ink, and the black ink based on the received color information and resolution.

In addition, the processor 610 may set resolution data, and the resolution data may be set as a high resolution greater than a predetermined reference value in a manufacturing process of the color panel 500.

The processor 610 may transmit a print signal to the print head 640 based on concentration data and resolution data, and the print head 640 may form the color layer 520 having a color corresponding to the received color information by ejecting the inks 521 and 522 onto the base panel 510 through the plurality of nozzles in accordance with the received print signal (1120). That is, a color corresponding to the received color information may be printed onto the front surface of the base panel 510 by using the digital printing device 600.

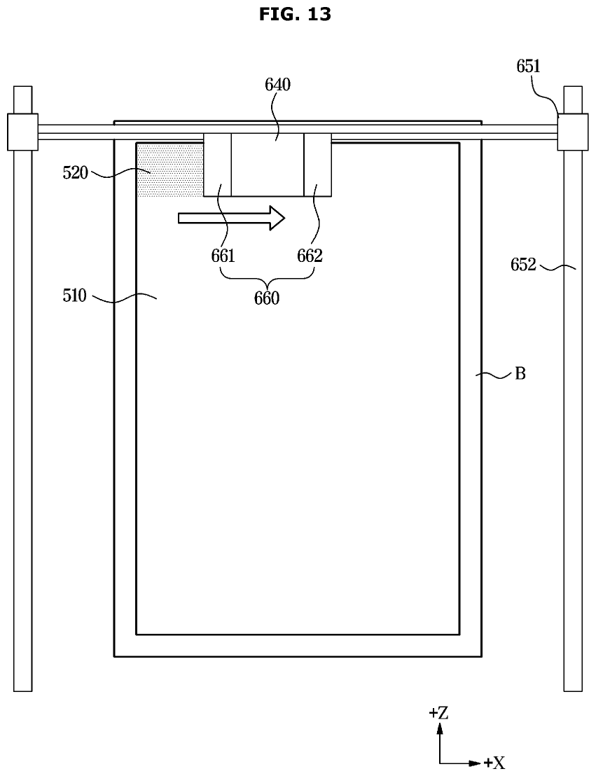

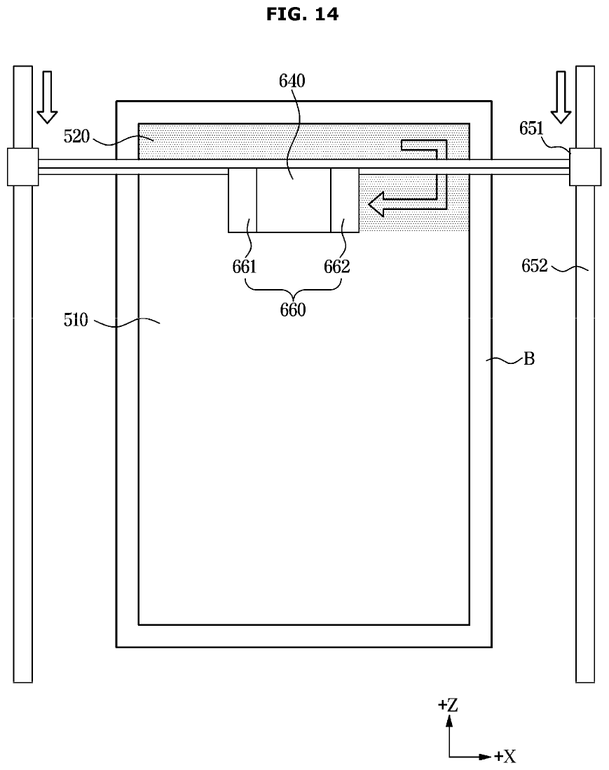

FIG. 13 and FIG. 14 are views illustrating example processes of forming a color layer according to a method for manufacturing a color panel according to an embodiment.

Referring to the example shown in FIG. 13, to form the color layer 520, the base panel 510 may be located on a printing bed B and may be fixed thereto.

The print head 640 may move in the X-axis direction (lateral direction) and in the Z-axis direction (longitudinal direction) above the base panel 510 located on the bed B. For example, as shown in FIG. 13, the print head 640 may eject ink through the plurality of nozzles while moving in the X-axis direction.

The print head moving assembly 650 for moving the print head 640 may include a support 651 to support the print head 640 and a guide rail 652 to guide the support 651 to move in the Z-axis direction. In addition, although not shown in the drawings, the print head moving assembly 650 may further include a motor to provide power for movement of the support 651 in the Z-axis direction and movement of the print head 640 in the X-axis direction, and a driving circuit for driving the same.

However, embodiments of the method for manufacturing the color panel are not limited to the structures illustrated in FIG. 13 and FIG. 14, and any manufacturing apparatuses other than those illustrated may also be applied as long as a color of the color panel 500 is realized by digital printing.

Regions printable by the print head 640 moving from the left end to the right end of the base panel 510 without moving in the Z-axis direction may be divided in units of line.

In this case, when the print head 640 has completed printing in a first line, the print head 640 may move in the Z-axis direction, and then perform printing in a next line in the X-axis direction, as shown in FIG. 14.

When printing of a previous line is performed while moving to the right (+X-axis direction), printing of a next line may be performed while moving to the left (−X-axis direction). That is, printing may be performed while moving in a zigzag direction.

Alternatively, the print head 640 may move to the left without ejecting inks, and then perform printing while moving to the right.

Alternatively, printing may be performed on the same line multiple times while moving opposite directions along the same line.

Lines on which printing is performed may or may not overlap each other. When the lines overlap each other, printing is performed multiple times on the overlapped region, and thus colors may be developed more clearly in the region.

Meanwhile, in a case where the digital printing device 600 uses an UV-cured ink, the ink ejected from the print head 640 requires to be cured by UV light. Accordingly, as shown in FIG. 13 and FIG. 14, the inks ejected from the print head 640 may be cured by UV light by mounting UV lamps 660 at both sides of the print head 640.

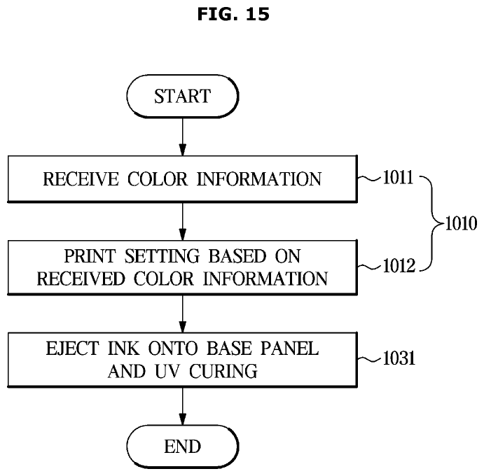

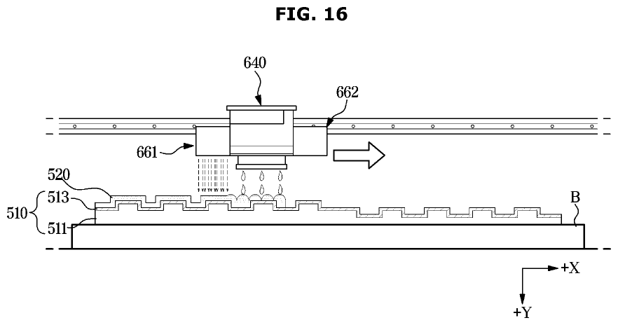

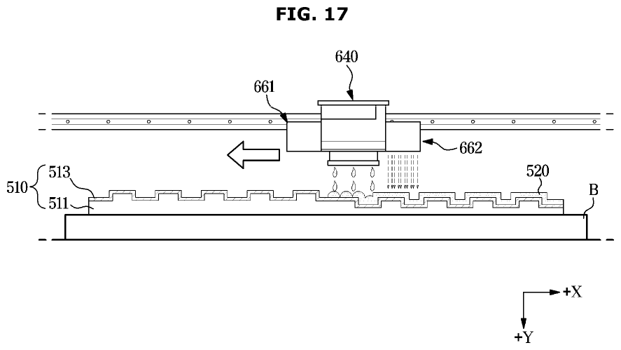

FIG. 15 is a flowchart of a method for manufacturing a color panel according to an embodiment in which ink ejection and UV curing are simultaneously performed. FIG. 16 and FIG. 17 are views for describing UV curing illustrated in FIG. 15.

Referring to FIG. 15, in a case of using the digital printing device 600, particularly, an inkjet printer using an UV-cured ink, the color layer 520 may be formed by performing UV curing simultaneously with ejection of the UV-cured inks 521 and 522 on the base panel 510 (1031). By simultaneously performing ink ejection and UV curing, color stability may be improved.

Referring to FIG. 16 and FIG. 17, the print head 640 may eject the inks 521 and 522 while moving in the X-axis direction and, simultaneously, the UV lamp 660 may cure the ejected inks 521 and 522 by emitting UV light. To this end, at least one of the two UV lamps 660 mounted at both sides (left and right sides) of the print head 640 may be turned on.

However, the expression ‘simultaneously curing’ does not refer to that a time point at which the inks 521 and 522 are ejected onto the base panel 510 is accurately the same as a time point at which UV light is emitted to the ejected ink. For example, an error of a time taken for the UV lamp 660 to move to a position corresponding to the ejected ink may be allowed. In a case where the UV curing is not performed separately from the ejection of the inks 521 and 522, the process may be expressed as ‘simultaneously curing’ although there is a time difference between ink ejection and UV curing.

Both the UV lamps 660 may be turned on regardless of a moving direction of the print head 640, or the UV lamps 660 may be selectively turned on in accordance with the moving direction of the print head 640.

For example, as shown in FIG. 16, when the print head 640 ejects the inks 521 and 522 while moving to the right (+X-axis direction), a UV lamp 661 mounted on the left side of the print head 640 may be turned on and a UV lamp 662 mounted on the right side of the print head 640 may be turned off.

Also, when the print head 640 completes ejection of the inks 521 and 522 while moving to the right, moves forward in the Z-axis direction, and ejects the inks 521 and 522 while moving to the left, the UV lamp 662 mounted on the right side of the print head 640 may be turned on and the UV lamp 661 mounted on the left side thereof may be turned off.

That is, the ejected inks 521 and 522 may be cured by turning on the UV lamp 660 mounted at a position opposite to the moving direction of the print head 640.

As described above, by selectively turning on/off the UV lamps 661 and 662 in accordance with the moving direction of the print head 640, unnecessary power consumption may be reduced.

Although a case in which one UV lamp 660 is mounted on each of the left and right sides of the print head 640 is described in the above-described example, the position and number of the UV lamps 660 are not limited thereto. For example, at least one UV lamp 660 may be mounted on each of the left and right sides of the print head 640, and the UV lamp 660 may be mounted only on the left side or only on the right side of the print head 640.

In a case where the UV lamp 660 is mounted only on the left or right side of the print head 640, a printing direction of the print head 640 may be limited to one direction. For example, in a case where the UV lamp 660 is mounted only on the left side of the print head 640, the print head 640 may eject the inks 521 and 522 while moving to the right. In a case where the UV lamp 660 is mounted only on the right side of the print head 640, the print head 640 may eject the inks 521 and 522 while moving to the left.

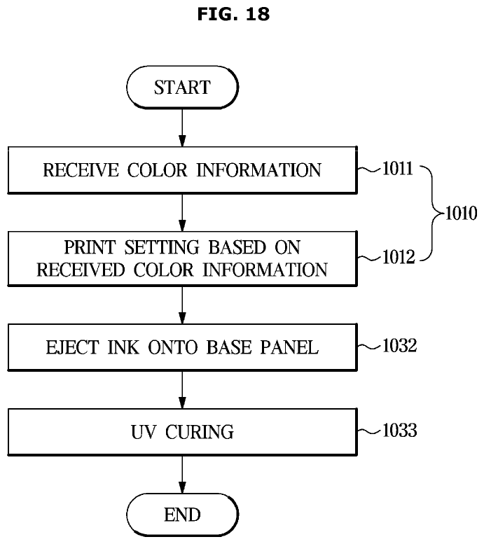

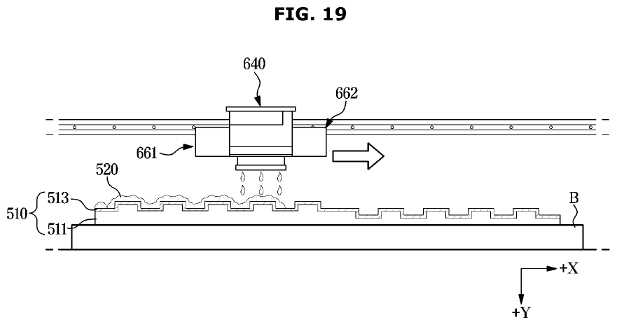

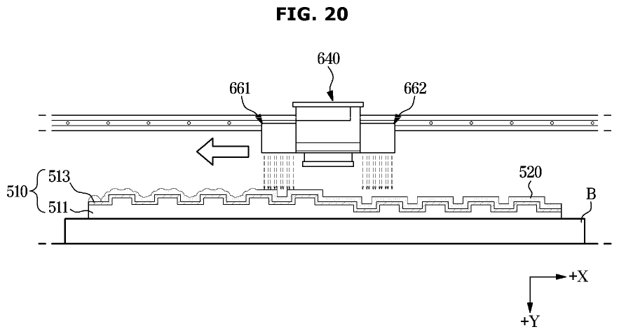

FIG. 18 is a flowchart of a method for manufacturing a color panel according to an embodiment in which UV curing is performed after inks are ejected. FIG. 19 and FIG. 20 are views for describing UV curing illustrated in FIG. 18.

Referring to FIG. 18, the operations of receiving color information (1011) and performing print setting (1012) have been described above, and thus descriptions thereof are omitted.

According to another example of the method for manufacturing the color panel, after the inks 521 and 522 are ejected onto the base panel 510 (1032), UV curing may be performed (1033). By performing the UV curing after ejection of the inks 521 and 522, a time during which ink droplets of different colors are mixed may be obtained to realize a desired color.

In this case, as shown in FIG. 19, the UV lamp 660 may be turned off while the print head 640 ejects the inks 521 and 522. As shown in FIG. 20, upon completion of the ejection of the inks 521 and 522, the UV lamp 660 may be turned on and perform curing of the ejected inks 521 and 522 while the print head 640 is moving.

For example, in a case where the print head 640 completes ejection of the inks 521 and 522 onto a single line while moving in the X-axis direction, UV curing may be performed on the same line while the print head 640 is moving in the X-axis direction opposite to the moving direction of ejection of inks 521 and 522 without moving forward in the Y-axis direction.

As another example, after the print head 640 completes ejection of the inks 521 and 522 over the entire front surface of the base panel 510, the UV lamp 660 may be turned on and perform UV curing over the entire front surface of the base panel 510 while moving again.

As described above, two or more UV lamps 660 may be mounted, or the UV lamp 660 may be mounted only on the left or right side of the print head 640.

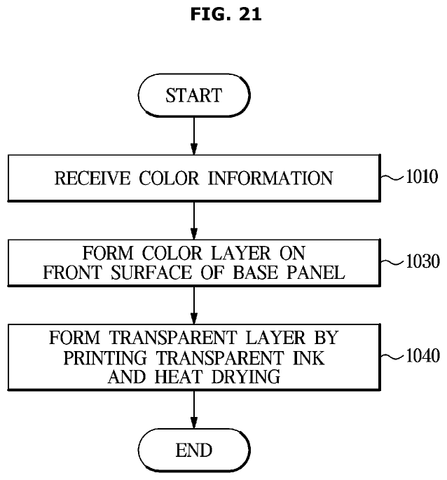

FIG. 21 is a flowchart of a method for manufacturing a color panel according to an embodiment further including an operation of forming a transparent layer.

As described above, after receiving the color information and performing print settings (1010), the color layer 520 may be formed on the front surface of the base panel 510 based on the color information (1030).

The method for manufacturing the color panel 500 may include forming the transparent layer 530 covering the color layer 520 on the color layer 520 (1040), after forming the color layer 520 on the front surface of the base panel 510 (1030).

The operation of forming the transparent layer 530 (1040) may include applying transparent ink on the color layer 520. Specifically, the operation of forming the transparent layer 530 (1040) may include a silk screen printing process of printing transparent ink on the color layer 520 and heat drying the printed transparent ink (1040). In this case, the transparent layer 530 may be formed faster, compared to forming the transparent layer 530 by digital printing, and productivity may be improved. However, the disclosure is not limited thereto, and the transparent layer 530 may be formed using digital printing.

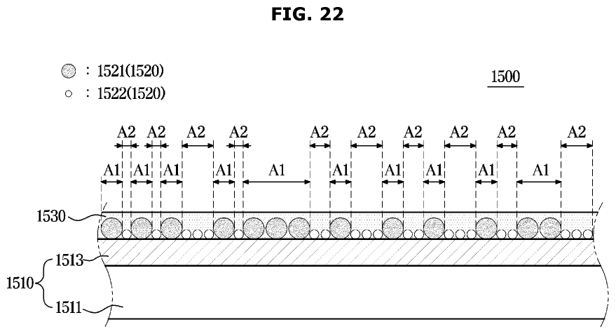

FIG. 22 is a side cross-sectional view of a color panel without a pattern according to another embodiment.

Referring to FIG. 22, a color panel according to another embodiment of the disclosure is described. In describing the embodiment shown in FIG. 22, the same reference numerals may be assigned to the same components as those shown in FIG. 1 to FIG. 21 and the description thereof may be omitted.

Referring to FIG. 22, a color panel 1500 included in at least one of the main bodies 10, 20, 30 and 40 or doors 100, 200, 300 and 400 of the home appliances 1, 2, 3 and 4 may include a base panel 1510 without a pattern, a color layer 1520 formed on the base panel 1510, and a transparent layer 1530 covering the color layer 1510.

The base panel 1510 may include a flat plate-shaped base 1511. In the above-described embodiment, the pattern portion 512 is formed on the front surface of the base 511 in order to express a three-dimensional texture. However, as shown in FIG. 22, the pattern portion 512 may not be formed on the front surface of the base 511.

A coating layer 1513 applied on a front surface of the base panel 1510 may be included. The coating layer 1513 may be formed on the base 1511, and may be applied to allow the coating layer 1513 to be formed in a flat plate shape corresponding to the flat plate-shaped base 1511.

In a case where inks 1521 and 1522 of the color layer 1520 are applied on the base panel 1510, the coating layer 1513 may include a material with a high bonding strength between the inks 1521 and 1522 to facilitate bonding between the inks 1521 and 1522 and the base panel 1510. Accordingly, the color layer 1520 may be stably formed on the base panel 1510. However, the disclosure is not limited thereto, and the coating layer 1513 may not be applied on the base panel 1510 as in the embodiment of FIG. 23.

The coating layer 1513 may be formed to have a predetermined color to allow a user to easily determine a color of the color layer 1520 to be formed on the base panel 1510. Specifically, the coating layer 1513 may have a white-based color. The white-based color of the coating layer 1513 satisfy L*=90 to 100, a*=−5.0 to 5.0, and b*=−5 to 5 in a CIE LAB color space (L* for brightness, and a* and b* for chromaticity indicating color and chroma). In addition, a visible light transmittance of the white-based color of the coating layer 1513 may be limited to 10% or less. However, the disclosure is not limited thereto, and the coating layer 1513 may be formed to have various colors.

The coating layer 1513 may be formed by silk screen printing, which includes applying coating ink and heat drying.

The color layer 1520 of the color panel 1500 may include a plurality of main ink dots 1521 and a plurality of sub ink dots 1522 smaller in size than the main ink dots 1521, and may be formed on the front surface of the base panel 1510. Specifically, the color layer 1520 may be formed by being applied on a front surface of the coating layer 1513 located on the front surface of the base panel 1510.

The color layer 1520 may be formed by digital printing. The ink dots 1521 and 1522 may be sprayed from an inkjet spraying device and may include a material that is cured by Ultra Violet (UV).

On the front surface of the base panel 1510, positions where the plurality of main ink dots 1521 are applied may be defined as a plurality of main areas A1, and positions where the plurality of sub ink dots 1522 are applied may be defined as a plurality of sub areas A2 that are distinguished from the plurality of main areas A1.

Even though a pattern portion with unevenness is not separately formed on the base panel 1510, the ink dots 1521 and 1522 of different sizes may require to be applied depending on a shape, color, and the like, of the color layer 1520 to be printed on the base panel 1510. Accordingly, in the method for manufacturing the color panel 1500, generating color information including location information about the plurality of main areas A1 and the plurality of sub areas A2, receiving the corresponding color information, and forming the color layer 1520 based on the received color information may be included. In this case, the color panel 1500 that provides a finer image than spraying only ink of a single size may be manufactured.

The color panel 1500 may include the transparent layer 1530 that covers the color layer 1520. The transparent layer 1530 may be made of a transparent material to allow a user to see the color layer 1520 through the transparent layer 1530.

The transparent layer 1530 may include a material having a hardness greater than that of the material of the color layer 1520. Accordingly, the transparent layer 1530 may protect the color layer 1520.

The transparent layer 1530 may include a material having similar physical and chemical properties to the color layer 1520 so as to be effectively bonded to the color layer 1520.

The transparent layer 1530 may include transparent ink. Specifically, the transparent layer 1530 may include transparent ink made of plastic resin material. However, the disclosure is not limited thereto, and the transparent layer 1530 may include various materials that may provide functions and properties of the above-described transparent layer 1530.

The transparent layer 1530 may be formed by silk screen printing, which includes printing transparent ink and heat drying.

FIG. 23 is a side cross-sectional view of a color panel without a coating layer according to still another embodiment.

Referring to FIG. 23, a color panel according to still another embodiment of the disclosure is described. In describing the embodiment shown in FIG. 23, the same reference numerals may be assigned to the same components as those shown in FIG. 1 to FIG. 21 and the description thereof may be omitted.

Referring to FIG. 23, a color panel 2500 included in at least one of the main bodies 10, 20, 30 and 40 or doors 100, 200, 300 and 400 of the home appliances 1, 2, 3 and 4 may include a base panel 2510 without a coating layer, a color layer 2520 formed on the base panel 2510, and a transparent layer 2530 covering the color layer 2520.

The base panel 2510 may include a metal material. Specifically, the base panel 2510 may include a steel plate material. Accordingly, the base panel 2510 may have properties such as sufficient rigidity, and a pattern portion 2512 may be easily formed on the base panel 2510. However, the disclosure is not limited thereto, and the base panel 2510 may include various materials.

The base panel 2510 may include the pattern portion 2512 that forms unevenness on a front surface of the base panel 2510. The pattern portion 2512 may include at least one of an embossed pattern 2512a that protrudes forward or an engraved pattern 2512b that is concave toward the rear. Operations of forming the embossed pattern 2512a or the engraved pattern 2512b may be the same as shown in FIG. 9 and FIG. 10.

The color layer 2520 may be formed by applying a plurality of main ink dots 2521 and a plurality of sub ink dots 2522 having a size smaller than the plurality of main ink dots 2521 on the front surface of the base panel 2510.

The color layer 2520 may be formed by digital printing, and may be formed by spraying ink dots 2521 and 2522 and curing the ink dots 2521 and 2522 by UV.

The plurality of sub ink dots 2521 may be applied between the plurality of main ink dots 2522, and at least a portion of the plurality of sub ink dots 2521 may be applied on a periphery of the pattern portion 2512.

At least a portion of the plurality of sub ink dots 2521 may be applied along an upper periphery of the embossed pattern 2512a. At least another portion of the plurality of sub ink dots 2521 may be applied along a lower periphery of the embossed pattern 2512a. At least another portion of the plurality of sub ink dots 2521 may be applied along a lateral periphery of the embossed pattern 2512a.

At least a portion of the plurality of sub ink dots 2521 may be applied along a lower periphery of the engraved pattern 2512b. At least another portion of the plurality of sub ink dots 2521 may be applied along an upper periphery of the engraved pattern 2512b. At least another portion of the plurality of sub ink dots 2521 may be applied along a lateral periphery of the engraved pattern 2512b.

The color panel 2500 may include the transparent layer 2530 that covers the color layer 2520. The transparent layer 2530 is made of a transparent material, and may include a material having a hardness equal to or greater than that of the material of the color layer 2520. The transparent layer 2530 may include a material having similar physical and chemical properties to the color layer 2520 so as to be effectively bonded to the color layer 2520.

The transparent layer 2530 may include transparent ink. The transparent layer 2530 may be formed by silk screen printing, which includes printing transparent ink and heat drying.

The transparent layer 2530 may be formed to have a shape corresponding to the unevenness of the pattern portion 2512.

Unlike the above-described embodiment, a coating layer may not be formed on the front surface of the base panel 2510.

In order to stably form the color layer 2520 on the front surface of the base panel 2510, a heat treatment process on the front surface of the base panel 2510 may be included before the ink dots 2521 and 2522 are applied on the front surface of the base panel 2510. By the surface heat treatment, the bonding strength between the surface of the base panel 2510 and the ink dots 2521 and 2522 of the color layer 2520 may be enhanced. Specifically, the surface heat treatment may include a plasma heat treatment. However, the disclosure is not limited thereto, and there may be various processes to ensure that the color layer 2520 is stably formed on the base panel 2510. Alternatively, the color layer 2520 may be formed on the front surface of the base panel 2510 without a separate processing process.

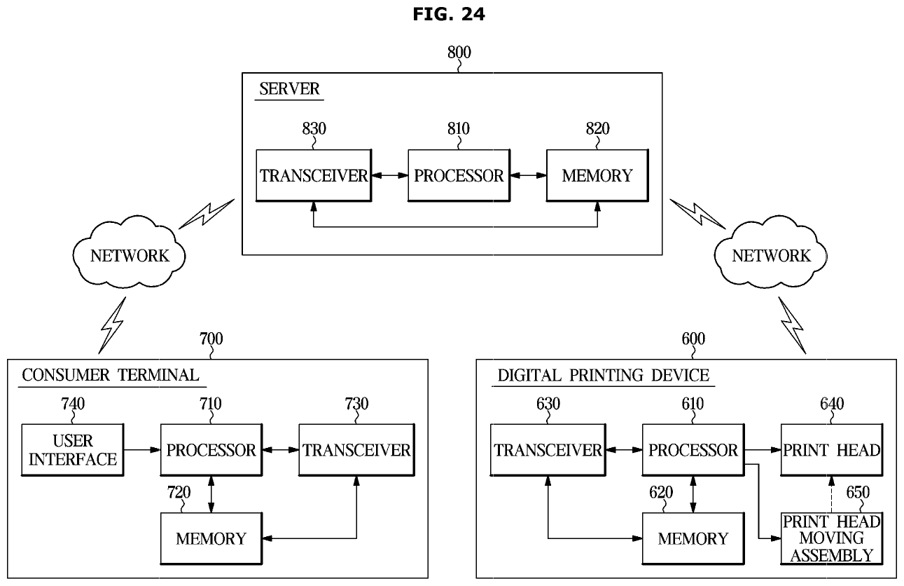

FIG. 24 is a control block diagram for describing a process of receiving color information to manufacture a color panel according to the embodiments of FIG. 1 to FIG. 23.

According to the embodiments of the color panels 500, 1500 and 2500 and the manufacturing methods thereof described above, the color layers 520, 1520 and 2520 of the color panels 500, 1500 and 2500 may be formed by receiving color information desired by a consumer, and performing digital printing based on the received color information. The process of receiving color information is described in detail.

First, a consumer may select a color of a home appliance using a consumer terminal 700. The selectable color of the home appliance may include a color of the door or the main body.

The consumer terminal 700 may be an electronic device including an input/output interface, such as a computer and a mobile device used by the consumer, or a computer, a mobile device, a digital signage, or a kiosk installed in a store for selling the home appliance.

The consumer terminal 700 includes a user interface 740 including a display and an input device, at least one processor 710 for controlling the consumer terminal 700, a memory 720, and a transceiver 730.

The user interface 740 may display an image for guiding selection of a color of the home appliance, and may receive an input of a color selected by the user. For example, the user interface 740 may display various colors selectable for each home appliance.

The processor 710 may store information about the selected color (hereinafter, referred to as color information) in the memory 720, and the transceiver 730 may transmit the color information stored in the memory 720 to a server 800 via a network. In this instance, information about the home appliance to which the selected color is applied may also be transmitted.

A transceiver 830 of the server 800 may receive the color information and home appliance information from the consumer terminal 700, and the received information may be stored in a memory 820.

A processor 810 may transmit the stored color information and home appliance information to a manufacturing system of the color panels 500, 1500 and 2500 via the transceiver 830. The transmitted color information and home appliance information may be received by a computer of the manufacturing system, and the received color information may be transmitted to the digital printing device 600 of the manufacturing system.

Operations performed by the digital printing device 600 are as described above with reference to FIG. 12.

As such, the color information of the home appliance selected through the consumer terminal 700 is transmitted to the digital printing device 600 via the server 800, and thus the color panels 500, 1500 and 2500 of the home appliance may be prepared in the make-to-order manufacturing method. Because color panels of the same color are not pre-manufactured in large quantities, an inventory issue may be solved, thereby providing a consumer with various options for the color of the home appliance.

Meanwhile, the color information transmitted from the consumer terminal 700 to the server 800 and the color information transmitted from the server 800 to the manufacturing system may be the same type or different types of information. For example, in a case where the color information transmitted from the consumer terminal 700 does not correspond to a color system used in the digital printing device 600, the external server 800 or the manufacturing system may convert the color information into information corresponding to the color system used in the digital printing device 600.

According to the embodiments described above, a color of a color panel used in home appliances may be realized by digital printing such as inkjet printing. Accordingly, each time printing is performed, a plurality of color inks may be sprayed in an appropriate ratio in accordance with input color information, and thus inks or toners are not required to be mixed in advance. Also, because the color information may be changed each printing process, various colors may be easily printed, and high productivity may be obtained even when printing is performed in a small quantities.

Based on the above-described advantages, a make-to-order manufacturing method in which a color panel is manufactured upon receiving an order for a home appliance from a consumer may be applied. Because color panels of the same color are not manufactured in advance in large quantities, an inventory issue may be solved, and thus a consumer may be provided with various options for the color of the home appliance.

In addition, ink dots (main ink dots and sub ink dots) forming a color layer may have two or more sizes, and color information may include information about the locations (main areas and sub areas) for each ink dot to be applied on a front surface of a base panel, thereby forming the color layer evenly. In particular, the ink dots having two or more sizes may be used, and thus an unpainted area where ink is not sufficiently applied on the base panel may be reduced.

Although disclosure has been shown and described in relation to specific embodiments, it would be appreciated by those skilled in the art that changes and modifications may be made in these embodiments without departing from the principles and scope of the disclosure, the scope of which is defined in the claims and their equivalents.

1. A home appliance, comprising:
a main body having an opening;
a door configured to open and close the opening; and
a color panel on at least one of the main body or the door, the color panel including:
a base panel including:
a front surface, and
an uneven pattern portion on the front surface, having upper sides, and lower sides that are at a height difference from the upper sides, and
a color layer on the uneven pattern portion and including:
main ink dots having a main ink dot size, and
sub ink dots having a sub ink dot size that is smaller than the main ink dot size,
wherein at least one sub ink dot of the sub ink dots is between each two adjacent main ink dots of the main ink dots, and at least some of the sub ink dots are on at least one of a periphery of the upper sides or a periphery of the lower sides.

2. The home appliance of claim 1, wherein
the uneven pattern portion includes an embossed pattern forming at least some of the upper sides and at least some of the lower sides,
at least some of the sub ink dots are on a periphery of the upper sides formed by the embossed pattern, and
at least some of the sub ink dots are on a periphery of the lower sides formed by the embossed pattern.

3. The home appliance of claim 2, further including lateral sides between the upper sides and the lower sides, wherein
at least some of the lateral sides connect the upper sides formed by the embossed pattern and the lower sides formed by the embossed pattern, and some of the sub ink dots are on the lateral sides connected by the embossed pattern.

4. The home appliance of claim 1, wherein
the uneven pattern portion includes an engraved pattern forming at least some of the upper sides and at least some of the lower sides,
at least some of the sub ink dots are on a periphery of the lower sides formed by the engraved pattern, and
at least some of the sub ink dots are on a periphery of the upper sides formed by the engraved pattern.

5. The home appliance of claim 4, further including lateral sides between the upper sides and the lower sides, wherein
at least some of the lateral sides connect the upper sides formed by the engraved pattern and the lower sides formed by the engraved pattern, and some of the sub ink dots are on the lateral sides connected by the engraved pattern.

6. The home appliance of claim 1, wherein the height difference is 30 micrometers or more.

7. The home appliance of claim 1, wherein the main ink dots and the sub ink dots include a material that is curable by ultraviolet light.

8. The home appliance of claim 1, wherein the color panel further includes a transparent layer at least partially covering the color layer.

9. The home appliance of claim 8, wherein a shape of the transparent layer corresponds to a shape of the uneven pattern portion.

10. The home appliance of claim 8, wherein the transparent layer includes a transparent ink.

11. The home appliance of claim 1, wherein
the base panel further includes a coating layer on the front surface, and
the color layer is on the coating layer.

12. The home appliance of claim 11, wherein the coating layer has a white color.

13. The home appliance of claim 11, wherein a shape of the coating layer corresponds to a shape of the uneven pattern portion.

14. A method for manufacturing a color panel, the method comprising:
receiving color information including:
main area location information about a plurality of main areas on an uneven pattern portion on a front surface of a base panel, and
sub area location information about a plurality of sub areas on the uneven pattern portion,
applying at least one main ink dot of a plurality of main ink dots on each main area of the plurality of main areas based on the main area location information and applying at least one sub ink dot of a plurality of sub ink dots on each sub area of the plurality of sub areas based on the sub area location information, to form a color layer on the base panel, wherein
each main ink dot of the plurality of main ink dots has a main ink dot size, and each sub ink dot of the plurality of sub ink dots has a sub ink dot size that is smaller than the main ink dot size, and
forming a transparent layer on the color layer.

15. The method of claim 14, further comprising:
forming a coating layer on the front surface of the base panel,
wherein the color layer is formed on the coating layer.
